(19) United States
(12) Patent Application Publication
(10) Pub. No.: US 2003/0058597 A1
(43) Pub. Date: Mar. 27, 2003

(54) Power converter device

(75) Inventors: Manfred Bruckmann, Nurnberg (DE); Max Beuermann, Erlangen (DE); Jurgen Biela, Nurnberg (DE); Matthias Braun, Florsbachtal (DE); Karl Fleisch, Erlangen (DE); Hubert Schierling, Erlangen (DE); Benno Weis, Hemhofen (DE)

Correspondence Address: Henry M. Feiereisen, Suite 3220, 350 Fifth Avenue, New York, NY, 10118, US

(73) Assignee: SIEMENS AKTIENGESELLSCHAFT, Munchen (DE)

(21) Appl. No.: 10/247,809

(22) Filed: Sep. 19, 2002

(30) Foreign Application Priority Data
Sep. 26, 2001 (DE) 101 47 472.5

(51) Int. Cl. H02H 3/00

(52) U.S. Cl. 361/100

(57) ABSTRACT

A power converter device includes a power part accommodated in a first casing, and an electronic part accommodated in a separate second casing. The power part and the electronic part are connected to one another through a signal transmission arrangement, e.g. a cable or a radio communication. The power converter device thus has spatially separated power and electronic parts to realize a thermal separation as well and to enable a more compact overall configuration.

### CROSS-REFERENCES TO RELATED APPLICATIONS

This application claims the priority of German Patent Application, Serial No. 101 47 472.5, filed Sep. 26, 2001, pursuant to 35 U.S.C. 119(a)-(d), the disclosure of which is incorporated herein by reference.

### BACKGROUND OF THE INVENTION

The present invention relates, in general, to a power converter device, and in particular to a power converter device of a type having a power part and an electronic part.

Commercially available power converter devices, also called frequency converter, have a power part and an electronic part, which are arranged within a common casing. The power part has a mains system side power converter and a load-side power converter which are electrically connected on the DC voltage side via an intermediate circuit. The mains system side power converter may simply be a diode bridge, whereas the load-side power converter has at least one converter valve, which is thermally connected with a heat sink to dissipate heat. Power converter devices may be configured as matrix converter.

In the event the mains system side power converter includes as converter valve controllable semiconductor switches that can be turned off, the frequency converter can be configured to feed back energy into the system. The mains system side power converter is then also designated as Active-Front-End (AFE). Further components of the power part includes, for example, a line-commutated inductor, a pre-charge relay, a control system for controlling converter valves, a power supply, a pulse resistance, intermediate circuit capacitors, a fan with pertaining heat sink, or other electric components. The electronic part includes at least one signaling electronics, which may include, for example, a control system with operating and communication devices. Moreover, the signal electronics may include, for example, microprocessors, application-specific integrated circuits (ASICs), logic components and/or analog integrated circuits, which are less prone to thermal stress.

In a frequency converter of this type, the electronic part is normally situated at a location above the power part, whereas the lower half of the converter accommodates the fan. This fan dissipates loss power produced in the power converter device. The heat sink of the fan is normally located in the vicinity of the back wall of the converter, whereas the converter valves of the power part are thermally connected with the heat sink to give off heat to the heat sink. The intermediate circuit capacitors with their busbars are positioned, for example, in a forward area of the converter in confronting relationship to the heat sink, and, together with other heavy components of the converter, are disposed in the lower half of the power converter device. The upper half of the power converter device accommodates, e.g., the electronic part. The electronic part is placed at a far enough distance from the heat-generating power part, so as to prevent heat from adversely affecting the electronic part. Commercially available power converter devices may be so configured that some parts of the power converter device such as, e.g., the control system, can be operatively connected to the power part as well as to the electronic part.

Other types of power converter devices are known which can be used in a decentralized drive system or in drives with several motors. Such a drive system supplies several load-side power converters from a common DC system, which is fed from a mains system side power converter. The load-side power converters, also called inverters, may be mounted to an electric machine for providing the power supply. An example of such a decentralized drive system is described in an article, entitled “Bewährte Servoantriebe für einen dezentralen Anlagenaufbau” {Proven servo drives for a decentralized system configuration], by Ralf Schweigert and published in magazine “Antriebstechnik” 38 (2000) No. 7. The power converter device with an electronic part and at least one power part is provided there for a decentralized system configuration.

There is an ever-increasing desire for a miniaturization of the overall size of power converter devices so as to make the power converter devices more compact. A consequence of the more compact construction of the power converter device is a closer positional relationship between the power part and the electronic part. Thus, the electronic part becomes more and more exposed to heat generation by the power part, e.g. through heat conduction, convection and/or heat radiation. As the electronic part is significantly less resistant to heat than the power part, the desire for a continued miniaturization of the power converter device is accompanied by problems, which cannot be ignored.

It would therefore be desirable and advantageous to provide an improved power converter device to obviate prior art shortcomings and to prevent a thermal coupling between a power part and an electronic part in a power converter device.

### SUMMARY OF THE INVENTION

According to one aspect of the present invention, a power converter device, includes a power part accommodated in a first casing, an electronic part accommodated in a separate second casing, and an arrangement for connecting the power part and the electronic part through signal transmission.

The present invention resolves prior art problems by accommodating the power part and the electronic part of the power converter device in separate casings so that the power part and the electronic part can be positioned in spaced-apart relationship and thus separated thermally from one another. The power part and the electronic part are connected through a signal transmission and thus can be constructed more compact because they are thermally decoupled as a result of the spatial distance. Heat generated by the power part can no longer adversely affect the electronic part through heat generation, heat conduction and/or convection.

The power part and the electronic part include each design-specific electric components. Normally, electric components for the power part can be exposed to higher temperatures than the electric components for the electronic part. Examples of typical electric components for the power part include power semiconductors. These power semiconductors represent heat sources of the power part. Examples of typical electric components for the electronic part include processors, which have typical temperatures of maximal 75° C. or 85° C.

According to another feature of the present invention, the power part may include a rectifier, an inverter having converter valves with pertaining control devices, and an intermediate circuit for electrically connecting the rectifier and the inverter, and the electronic part may include a signaling electronics.

A control system controls a converter valve of the inverter. The intermediate circuit is either a current intermediate circuit or a voltage intermediate circuit with intermediate circuit capacitors. Depending on their type, capacitors vary in their sensitivity to high temperatures. Typically, the maximum operating temperature of the capacitors is above 100° C. so that the capacitors have to be separated thermally from heat sources in the power part. This may be realized either through spatial separation or through integration of a thermal separation. The placement of the control system or other electric components in the power part requires same considerations as far as heat is concerned as the placement of the capacitors. The power part can be optimized in its casing with respect to its power per volume unit because the power part is thermally decoupled from the electronic part by the spaced-apart relationship.

The electronic part is provided with a signaling electronics, which includes heat-sensitive electric components that are now protected as a result of the thermal separation from the heat sources of the power part.

According to another feature of the present invention, the power part may have an inverter including converter valves with pertaining control devices, whereas the electronic part may include a signaling electronics. In contrast to a frequency converter, the inverter of the power part has a mains system side DC terminal. The advantage of the spatial separation between power part and electronic part in their casings are the same as described previously in connection with the power converter device having a power part, which also includes a rectifier.

According to another feature of the present invention, each converter valve may be a controllable semiconductor switch, which can be turned off and is made of silicon carbide. The thermal separation between power part and electronic part is especially advantageous in cases when the loss power of the converter valve increases. A converter valve made of silicon carbide (SiC) can be exposed to greater temperatures than converter valves made of silicon (Si). The use of silicon carbide for power converter switches results in a higher current-carrying capability compared to power converter switches of silicon. In the case of SiC, a depletion layer temperature of, for example, 200° C. results in a heat sink temperature in power converter switches of about 140° C. By increasing the resistance against a higher temperature load, the complexity for establishing sufficient heat dissipation can be minimized. As a result, the power part can be configured more compact so that the power per volume unit increases. The spatial separation and thus thermal separation between power part and electronic part does not adversely affect the electronic part, when the temperature is increased in the power part. Both, power part and electronic part, are separated from one another and optimized as far as thermal aspects are concerned so that the service life of these parts is much improved and/or the failure rate is significantly decreased.

According to another feature of the present invention, the power part forms with an electric machine a structural unit. Since an electric machine as well as the power part can be exposed to higher temperatures than the electronic part of power converter devices, it is possible to unite the power part of the power converter device with the electric machine to form a unitary structure. Such construction also takes into account a development of decentralized drive systems because the power part, which feeds power to the electric machine, is combined therewith. The construction is simplified and better to monitor.

According to another aspect of the present invention, a power converter assembly, includes at least two power converter devices, with each power converter device including a power part accommodated in a first casing, an electronic part accommodated in a second casing, and an arrangement for connecting the power part and the electronic part through signal transmission, wherein the electronic part of one power converter device and the electronic part of the other power converter device form a structural unit.

The electronic parts of several power converter devices are constructed separate from the power part of the power converter device. As the electronic parts of several power converter devices can be positioned at any suitable site, it is possible to unite the electronic parts to form a structural unit. This improves maintenance works because maintenance can be carried out at that site and allows the use of a single outer casing for the electronic parts of at least two power converter devices so that manufacturing costs can be saved.

According to another feature of the present invention, the structural unit of electronic parts of at least two power converter devices can be a component carrier, which accommodates the electronic parts of the power converters devices. Components of different electronic parts can easily be integrated in a component carrier. This allows the central construction of the electronic parts.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 is a schematic illustration of a first embodiment of a power converter device according to the present invention;

FIG. 2 is a schematic illustration of a second embodiment of a power converter device according to the present invention;

FIG. 3 is a schematic illustration of a power converter assembly with power converter devices according to FIGS. 1 and 2;

FIG. 4 is a circuit diagram of a power converter device according to FIG. 1;

FIG. 5 is a circuit diagram of a power converter assembly according to FIG. 4; and

FIG. 6 is a circuit diagram of another power converter assembly with power converter devices according to the present invention.

### DETAILED DESCRIPTION OF PREFERRED EMBODIMENTS

Throughout all the Figures, same or corresponding elements are generally indicated by same reference numerals.

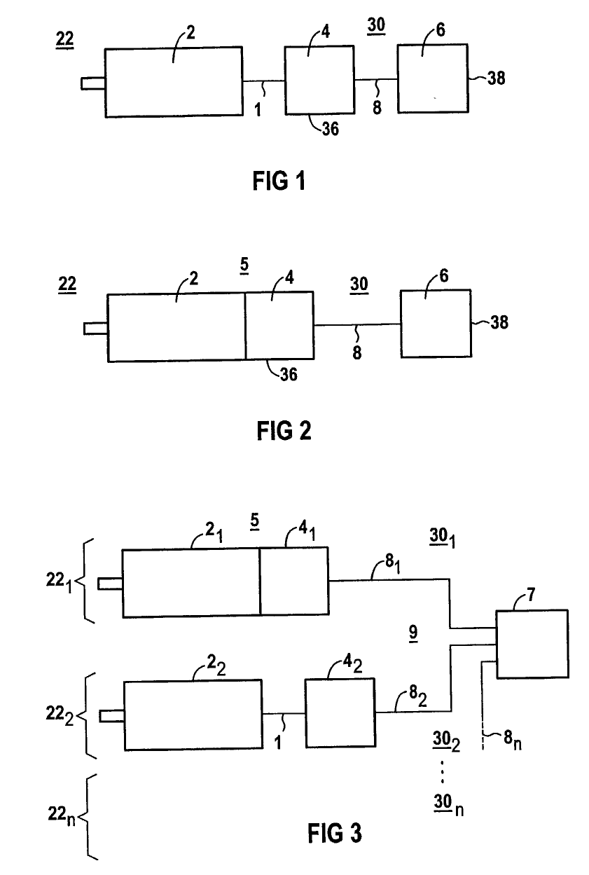

Turning now to the drawing, and in particular to FIG. 1, there is shown a schematic illustration of a first embodiment of a power converter device according to the present invention, generally designated by reference numeral 30. The power converter device 30 defines with an electric motor 2 a drive train 22 and includes a power part 4, accommodated in a casing 36, and an electronic part 6, accommodated in a separate casing 38. The power part 4 is connected to the electric motor 2 via a power linkage 1 and is connected by a signal transmission arrangement 8 with the electronic part 6. Examples of such a signal transmission arrangement 8 include a cable or a radio communication. The power part 4 and the electronic part 6 define together with the signal transmission arrangement 8 the power converter device 30, whereby the casings 36, 38 can be positioned in spaced-apart relationship so as to be thermally separated from one another.

FIG. 2 shows an alternative embodiment of a power converter device according to the present invention, with drive train 22 comprised of electric motor 2 and pertaining power converter device 30. Parts corresponding with those in FIG. 1 are denoted by identical reference numerals and not explained again. In this embodiment, provision is made for a structural unit 5 that unites the power part 4 with the electric motor 2. The electric motor 2 as well as the power part 4 allow high maximum operating temperatures. By uniting the power part 4 with the electric motor 2 to form the structural unit 5, the power converter device 30 has a compact configuration.

Referring now to FIG. 3, there is shown a schematic illustration of a drive system, generally designated by reference numeral 9, with n electric motors 2₁, 2₂, , 2ₙ in connection with power parts 4₁, 4₂, . . . , 4ₙ, whereby the plurality of electric motors 2₁, 2₂, . . . , 2ₙ and the plurality of power parts 4₁, 4₂, . . . , 4ₙ.are placed in one-to-one correspondence and form a plurality of drive trains 22₁, 22₂, . . . , 22ₙ. In the drive train 22₁, the power part 4₁ of power converter device 30₁ defines with the electric motor 2₁ a structural unit 5 according to FIG. 2. In the drive train 22₂, the electric motor 2₂ is connected to the power part 4₁ of power converter device 30₂ via power linkage 1 according to the embodiment of FIG. 1, and thus separated therefrom. The electronic parts 6₁, 6₂, . . . , 6ₙ of the power converter devices 30₁, 30₂, . . . , 30ₙ in the drive trains 22₁, 22₂, . . . , 22ₙ.are united in a common structural unit 7.

Persons skilled in the art will understand that the drive system 9 of FIG. 3 is shown by way of example only. Of course, the drive system may be composed of drive trains 22 in any desired fashion, i.e. it may contain several drive trains 22ₓ according to the embodiment of FIG. 1, or according to the embodiment of FIG. 2, or may be composed of a combination of power converter devices according to the embodiments of FIGS. 1 and 2.

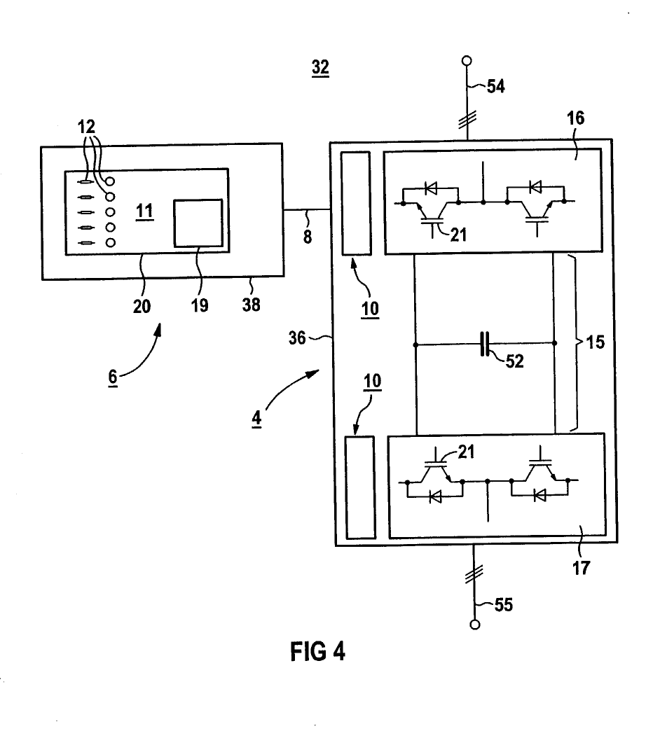

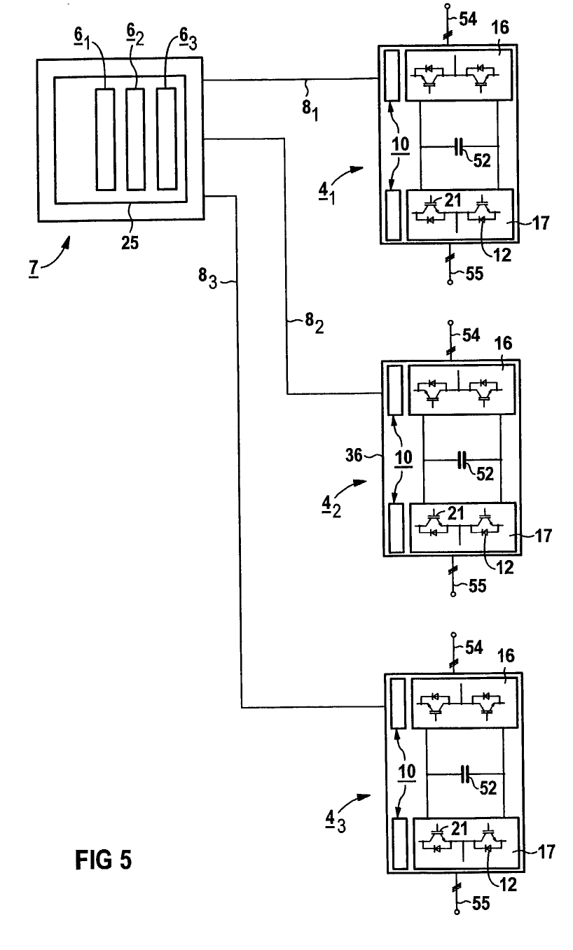

Turning now to FIG. 4, there is shown an actual circuit diagram of a power converter device in the form of a frequency converter, generally designated by reference numeral 32. The frequency converter 32 is configured according to the power converter device of FIG. 1. The electronic part 6 of the frequency converter 32 includes a signal transmission arrangement 11 with electric components 12 and at least one processor 19 mounted on a circuit board 20. Operation and structure of such a signal transmission arrangement is generally known to the artisan and not explained in detail for sake of simplicity.

The power part 4 of the frequency converter 32 has an active-front-end 16 and an inverter 17 with semiconductor switches 21. A group of control device 10 is operatively connected to the semiconductor switches 21. The active-front-end 16 is connected to the inverter 17 via an intermediate circuit 15 which includes at least one capacitor 52. The power part 4 is fitted in casing 36 and has a mains system side terminal 54 to a power supply, and a load-side terminal 55 to, e.g., an electric machine. The electronic part 6 is accommodated in casing 38.

FIG. 5 illustrates a power converter system with three power converter devices in the form of frequency converters according to FIG. 4. Each frequency converter has a power part 4₁, 4₂, 4₃ and an electronic part 6₁, 6₂, 6₃, whereby the electronic parts 6₁, 6₂, 6₃ of the frequency converters are united in a structural unit 7. The electronic parts 6₁, 6₂, 6₃ are disposed in a component carrier 25 which is enclosed by the casing 38. The power parts 4₁, 4₂, 4₃ of the frequency converters are connected to the electronic parts 6₁, 6₂, 6₃ by signal transmission arrangements 8₁, 8₂, 8₃. In the event any of the electronic parts 6₁, 6₂, 6₃ requires an external power supply, the structural unit 7 can be advantageously constructed to include a terminal for connection to the external power supply so that the cabling complexity is greatly reduced.

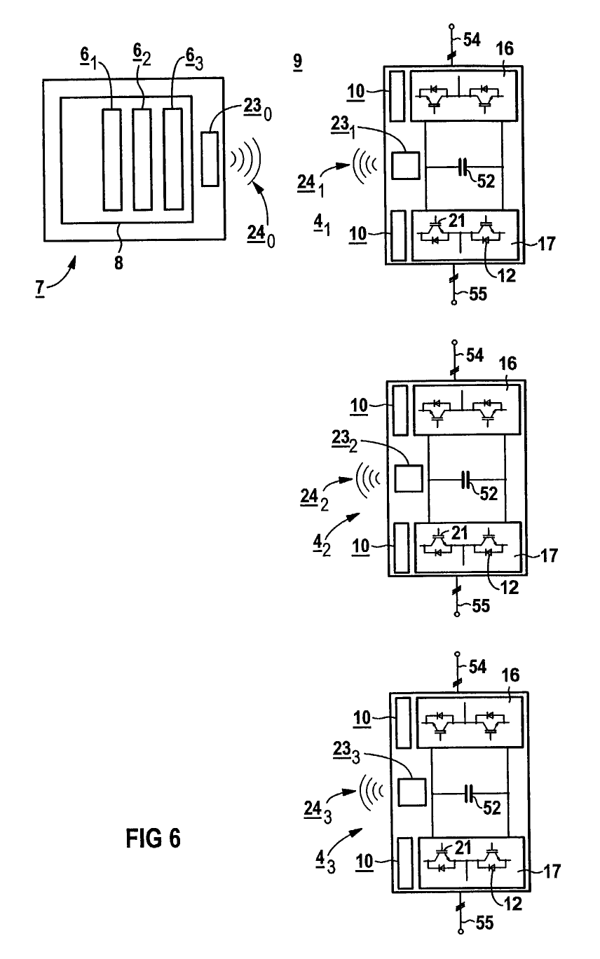

FIG. 6 shows another variation of a power converter system 9 with three power converter devices in the form of frequency converters. In this embodiment, provision is made for a signal transmission arrangement in the form of a radio communication 24₀, 24₁, 24₂, 24₃ for connecting the electronic parts 6₁, 6₂, 6₃ with the power parts 4₁, 4₂, 4₃. The radio communications 24₀, 24₁, 24₂, 24₃ can be implemented via transmitter-receiver units 23₀, 23₁, 23₂, 23₃. Operation and structure of such radio communications is generally known to the artisan so that a detailed description thereof is omitted for sake of simplicity. The designation of indices enables an association to the power converter devices. The use of radio communication simplifies the configuration of the power converters.

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and their equivalents:

What is claimed is:

1. A power converter device, comprising:
a first casing;
a power part accommodated in the first casing;
a second casing;
an electronic part accommodated in the second casing; and
linkage means for connecting the power part and the electronic part through signal transmission.

2. The device of claim 1, wherein the power part includes a rectifier, an inverter having converter valves with pertaining control components, and an intermediate circuit electrically connecting the rectifier to the inverter, wherein the electronic part includes a signaling electronics.

3. The device of claim 1, wherein the power part includes an inverter having converter valves with pertaining control components, wherein the electronic part includes a signaling electronics.

4. The device of claim 2, wherein each said converter valve is a controllable semiconductor switch which can be turned off and is made of silicon carbide.

5. The device of claim 3, wherein each said converter valve is a controllable semiconductor switch which can be switched off and is made of silicon carbide.

6. The device of claim 1, wherein the power part is connected to an electric machine for supply of power, said power part forming a unitary structure with the electric machine.

7. The device of claim 1, wherein the linkage means includes at least one cable.

8. The device of claim 1, wherein the linkage means includes a radio communication.

9. The device of claim 2, wherein the intermediate circuit is one of a current intermediate circuit and a voltage intermediate circuit with intermediate circuit capacitors.

10. A power converter assembly, comprising at least two power converter devices, each power converter device including a power part accommodated in a first casing, an electronic part accommodated in a separate second casing, and linkage means for connecting the power part and the electronic part through signal transmission, wherein the electronic part of one power converter device and the electronic part of the other power converter device form a structural unit.

11. The assembly of claim 10, wherein the structural unit is a component carrier which accommodates the electronic parts of the at least two power converters.

12. The assembly of claim 10, wherein the linkage means for connecting the power part and the electronic part through signal transmission includes at least a cable.

13. The assembly of claim 10, wherein the linkage means for connecting the power part and the electronic part through signal transmission includes a radio communication.
